(19) United States
(12) Patent Application Publication
(10) Pub. No.: US 2011/0155494 A1
(43) Pub. Date: Jun. 30, 2011

(54) ELECTRICAL POWER SUPPLY UNIT AND METHOD FOR CHARGING ACCUMULATORS OF AN ELECTRIC POWER SUPPLY UNIT AND LIGHT ELECTRIC VEHICLE WITH ELECTRIC POWER SUPPLY UNIT

(76) Inventor: Robert Haas, Marquartstein (DE)

(21) Appl. No.: 12/992,896

(22) PCT Filed: May 13, 2009
(86) PCT No.: PCT/IB2009/051965

§ 371 Date: Dec. 15, 2010

(30) Foreign Application Priority Data
May 13, 2008 (DE) 102008023291.2
May 13, 2008 (DE) 102008023292.0

(51) Int. Cl. B62M 6/00; H02J 7/00

(52) U.S. Cl. 180/206.1; 320/167

(57) ABSTRACT

Electric power supply unit and method for charging accumulators of an electric power supply unit and light electric vehicle with electric power supply unit

According to the invention an electric drive system is provided for a vehicle. In it is provided a fuel cell for generating a first voltage. Connected to this first voltage is a series connection of accumulators with at least one first accumulator and one second accumulator. A transformer comprises a magnetisable core, wherein the term magnetisable is understood to mean that the magnetic field strength of the core can be changed. In addition, the transformer comprises a primary coil, a first secondary coil and a second secondary coil. The first primary coil can be connected switchably to the first voltage. A first secondary switch is provided to connect the first secondary coil in parallel to the first accumulator. The electric drive system also comprises a second secondary switch for connecting the secondary coil in parallel to the second accumulator. The first secondary switch and the second secondary switch can be switched independently of one another.

The invention relates to an electric power supply unit and a method for charging accumulators of an electric power supply unit. Electrically operated motors for vehicles are frequently supplied with high voltages so that energy is transmitted to the motor with the lowest possible transmission losses. If the energy to provide the high voltages is stored in accumulators they are frequently connected in series so that each individual accumulator provides only part of the total voltage.

Light electric vehicles are understood to be two-, three- or four-wheeled vehicles with an electric drive which has a maximum rated capacity of no more than 4 kW. The vehicles have a kerb weight of not more than 350 kg excluding the weight of the batteries. They may be bicycles with auxiliary motor, wheelchairs, motorised bicycles, mopeds or motor scooters, for example, and all have in common the fact that they are electrically driven. One example of such a battery-operated light electric vehicle is shown in DE 20 2005 006684 U1.

As the energy for the electric motor of a light vehicle has to be carried on the vehicle during operation, particular care is devoted to ensuring an energy-saving drive unit. It has been shown that accumulators present different capacities as they age and are therefore charged by different amounts. As a result, on one hand the available charging capacities are not fully used and on the other hand there is a risk that individual accumulators will be overcharged and thus become defective. For example, U.S. Pat. No. 5,726,551 shows a battery charging unit in which the individual accumulators are charged successively to avoid current spikes. However, such a device presents the problem described above that the individual accumulators can be overcharged.

The object of the invention is thus to provide an electric power supply unit in which the overcharging of individual accumulators can be prevented. A further object of the invention is to provide a corresponding method for charging accumulators of these electric power supply units. It is also the object of the invention to provide a light electric vehicle with an electric power supply unit in which the overcharging of individual accumulators can be prevented.

These objects are achieved by the subject matter of the independent claims. Advantageous versions are detailed in the dependent claims.

According to the invention an electric drive system is provided for a vehicle. Therein, a power source is provided, preferably a fuel cell, for generating a first voltage. Connected to this first voltage is a series connection of accumulators with at least one first accumulator and one second accumulator. A transformer comprises a magnetisable core, wherein magnetisable is understood to mean that the magnetic field strength of the core can be changed.

In addition, the transformer comprises a primary coil, a first secondary coil and a second secondary coil. The first primary coil can be connected switchably to the first voltage by a primary switch. A first secondary switch is provided to connect the first secondary coil in parallel to the first accumulator. The electric drive system also comprises a second secondary switch to connect the second secondary coil in parallel to the second accumulator. The first secondary switch and the second secondary switch can be switched independently of one another.

The electric power supply unit is configured such that the accumulators can be charged or discharged individually. In addition, it is possible to charge all the accumulators simultaneously from the energy stored in the first voltage. As the primary coil can be connected to the first voltage, the energy from one individual accumulator can be transmitted to the entire series connection of accumulators. In addition, energy from the series connection of accumulators can be fed to one individual accumulator or to a selection of accumulators.

However, the electric power supply unit also enables energy from one of the secondary coils to be transmitted to another secondary coil and thus enables direct compensation for different charge states. If the secondary switches comprise MOS transistors the power loss is reduced. This also saves energy.

In a preferred embodiment the power supply device comprises a measuring circuit for measuring the voltage at a terminal of the primary coil or for measuring the current into the primary coil. By switching one of the secondary switches it is possible to measure the voltage applied at the corresponding accumulator on the primary side. Using this measuring circuit it is thus possible to measure the voltages at all the accumulators individually without having to provide individual measuring circuits on the secondary side. In addition, the same measuring circuit can be used to measure the level of the first voltage.

Alternatively or additionally a measuring circuit can be provided for measuring the voltage at a terminal of a secondary coil or the current into a secondary coil. If the primary switch and the secondary switch are wired appropriately the voltages applied at the primary coils and the voltages applied at the secondary coils are able to change the voltage at the terminal which is connected to the measuring circuit.

In a further embodiment, a selector switch is provided for selecting at least one connection from the measuring circuit to a terminal of one of the secondary coils. In this variant it is possible to measure a voltage at a secondary coil using the multiplexer, wherein only one measuring circuit is required for the plurality of voltages.

Alternatively or additionally a measuring circuit can be provided for measuring the voltage at a terminal of a secondary coil or the current into a secondary coil. If the primary switch and the secondary switch are wired appropriately the voltages applied at the primary coils and the voltages applied at the secondary coils are able to change the voltage at the terminal which is connected to the measuring circuit.

If the first voltage is applied at a stack of a fuel cell the pumps usually provided in a fuel cell become redundant. A stack consists of a plurality of metal layers. The voltage generated is provided at the two outer metal layers. The voltage generated is usually highly load-dependent, but the transformer presented permits the direct actuation of the stack. The circuit is particularly suitable for hydrogen fuel cells.

In a further embodiment a selector switch is provided for selecting at least one connection from the measuring circuit to a terminal of one of the secondary coils. In this variant it is possible to measure a voltage at a secondary coil using the multiplexer, wherein only one measuring circuit is required for a plurality of voltages.

In one embodiment a DC/DC converter is provided between the fuel cell and the first voltage. This is particularly recommended if the fuel cell used provides a voltage which is lower than the voltage best suited to the motor. For example, a standard methanol fuel cell provides a voltage of 24V. To operate the motor, however, higher voltages are preferred so that power can be transmitted from the energy store to the motor with as little loss as possible. The DC/DC converter thus enables the voltage to be adapted to the desired operating voltage of the electric motor.

In one embodiment, a charging circuit is also provided for charging the accumulators and/or charging the fuel cell from an external electrical power source. By means of the charging circuit it is possible to use efficiently generated power from a supply network, for example, to charge the accumulators or the fuel cell. If additional energy is to be transported and stored in the fuel cell it must be a reversible fuel cell.

If the accumulators take the form of lithium ion accumulators, it is possible to store considerable energy in a relatively small space. However, it is important to ensure that none of the accumulators is overcharged. One embodiment includes a control circuit for switching the secondary switch.

The invention is particularly suitable for a pedal-operated vehicle with electrical support, particularly a bicycle. In such a vehicle, a human-powered drive system and an electric drive system are provided, wherein a power output from the electric drive system is controlled in accordance with the changes in the output of the human-powered drive system. In such bicycles with auxiliary motors, the space for the fuel is particularly limited and an energy-saving transmission of energy to the accumulator significantly increases the range of the vehicle.

The invention also provides a method for charging accumulators of an electric energy supply unit of a vehicle according to the invention. It also provides an electric power supply unit provided according to the invention.

First, the primary switch is closed and then opened again. Then the first secondary switch is closed. Energy can thus be transmitted selectively from the series connection of accumulators to an individual accumulator. The charging of the accumulators is simplified since the power source supplies the first voltage. The corresponding energy can be distributed relatively simply to the individual accumulators by the method according to the invention.

In one embodiment the following steps are carried out before the primary switch closure step:
opening of the primary switch and the secondary switch,
measurement of the voltage applied at the first accumulator and measurement of the voltage applied at the second accumulator.

Thus it is possible to measure which of the accumulators is appropriately to be charged next.

If the voltage applied at the first accumulator is greater than the voltage applied at the second accumulator, a step involving the subsequent closure of the second secondary switch is preferably carried out rather than the step involving the subsequent closure of the first secondary switch. The accumulator with the lower applied voltage is thus charged.

In one embodiment the measurement is carried out such that the voltage at the first accumulator is measured by measuring the voltage at a terminal of the primary coil or by measuring the current into the primary coil. As a result, all the voltages at the accumulator can be measured with one single measuring circuit. Compared to devices with several measuring circuits this gives the advantage that production differences between the various measuring circuits cannot cause measuring errors.

In a further embodiment the power supply system contains at least one further series connection of accumulators. A further coil is provided which can be connected to the voltage at the first series connection of accumulators. Thus, the voltage can also be transmitted from one accumulator to one of several series connections if only the voltage at this series connection is too low.

In one embodiment the threshold value is calculated using the voltages at the accumulators of the series connection, thereby charging the accumulators evenly.

Embodiments of the invention are described in greater detail below with reference to the attached drawings.

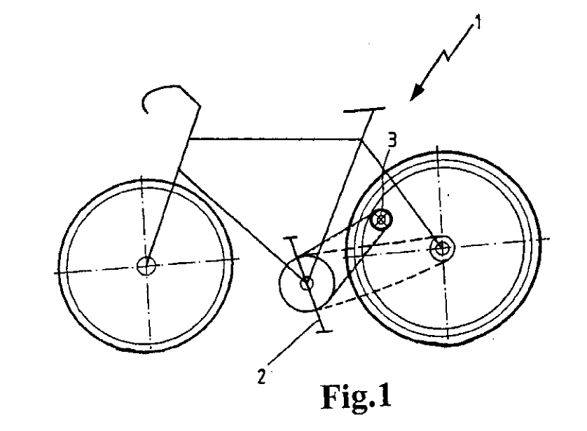

FIG. 1 shows a pedal-driven vehicle.

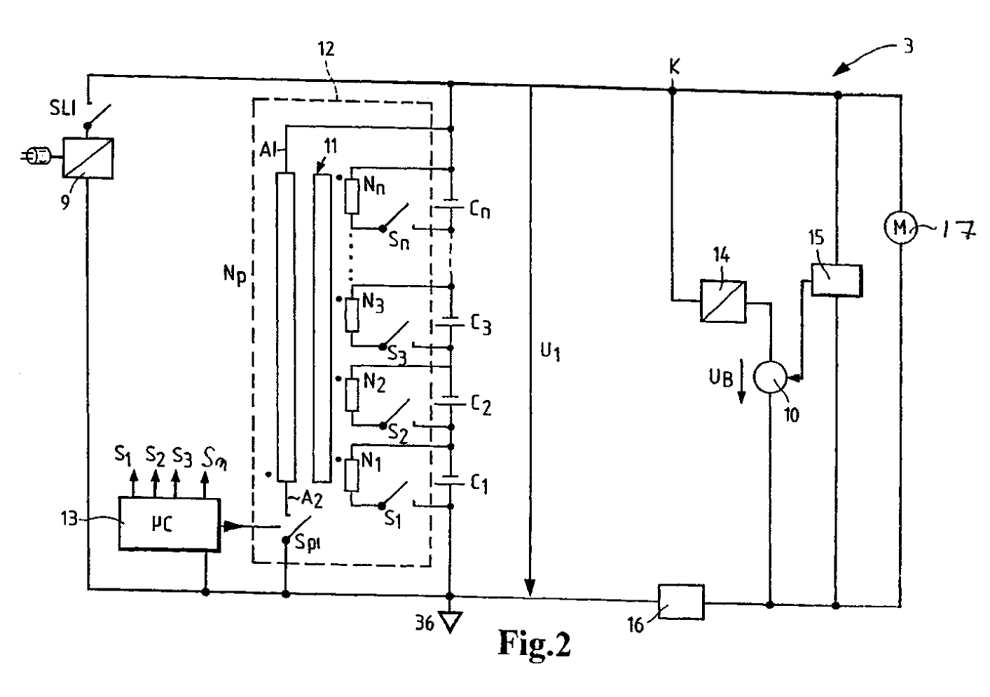

FIG. 2 shows an electric drive system of the vehicle illustrated in FIG. 1.

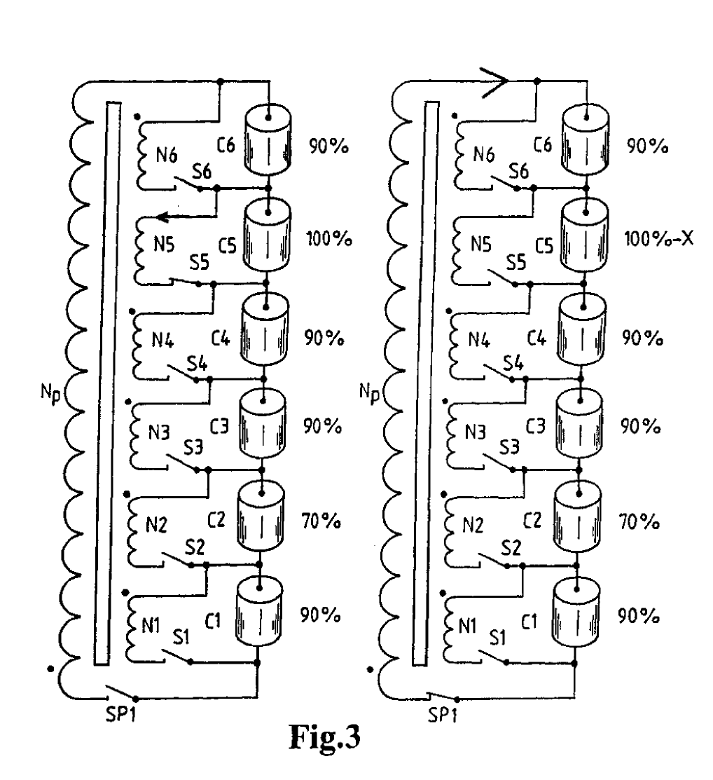

FIG. 3 shows the discharging of an accumulator in the electric drive system.

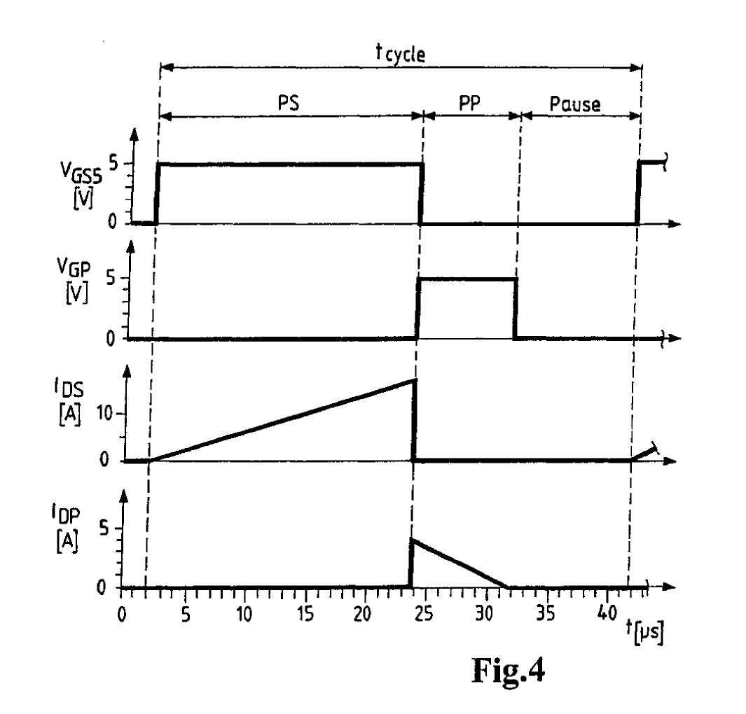

FIG. 4 shows the signal curve for discharging the accumulator.

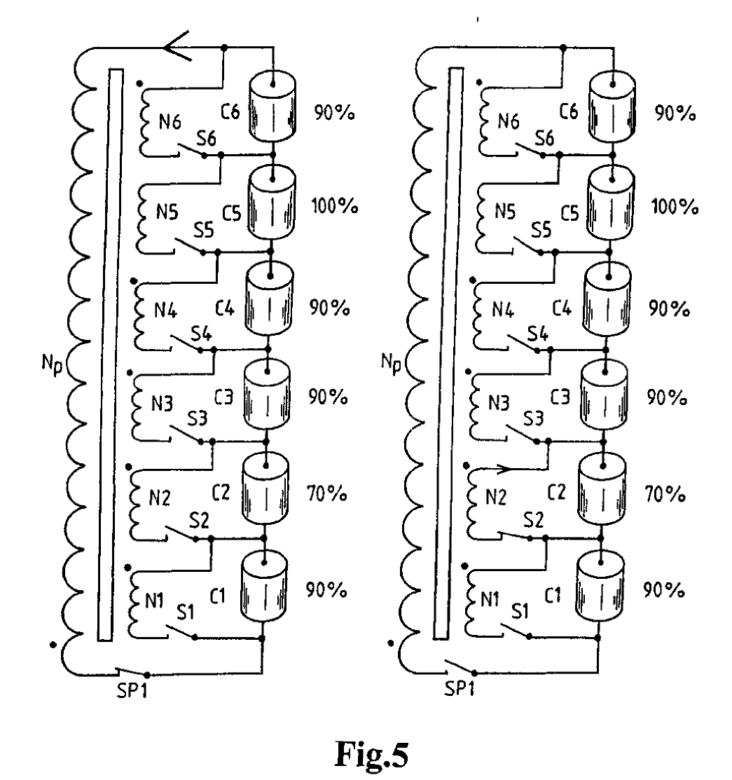

FIG. 5 shows the charging of an accumulator in the electric drive system.

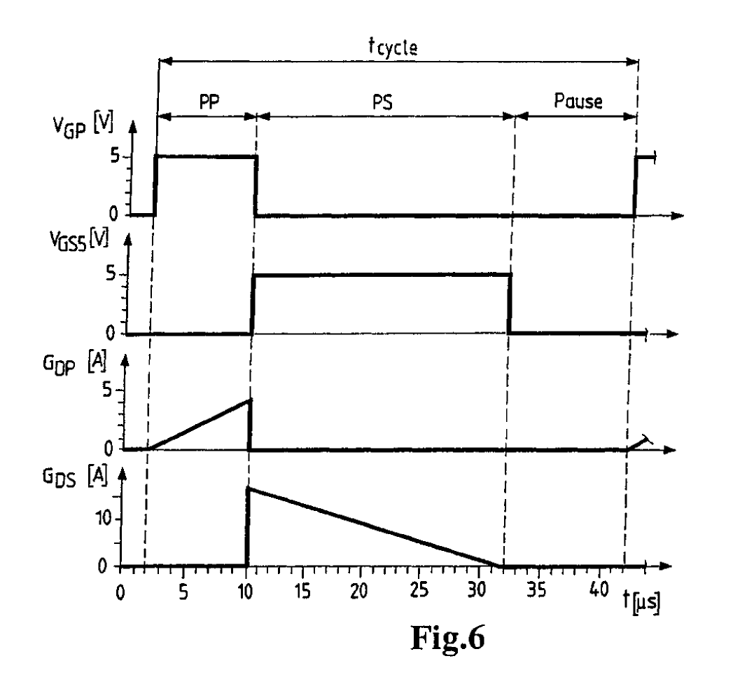

FIG. 6 shows the signal curves for charging the accumulator.

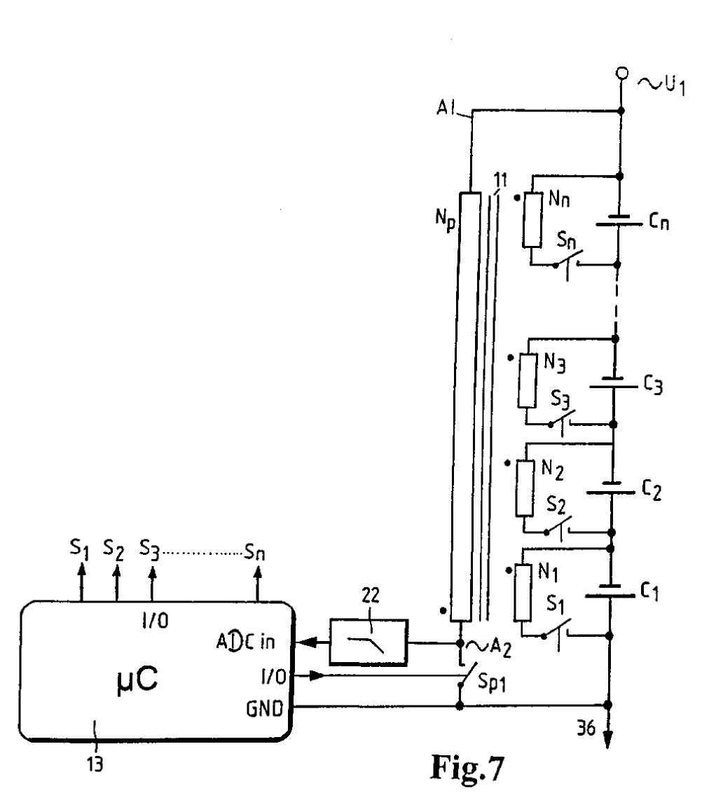

FIG. 7 shows a schematic diagram for measuring the charge statuses of the accumulators.

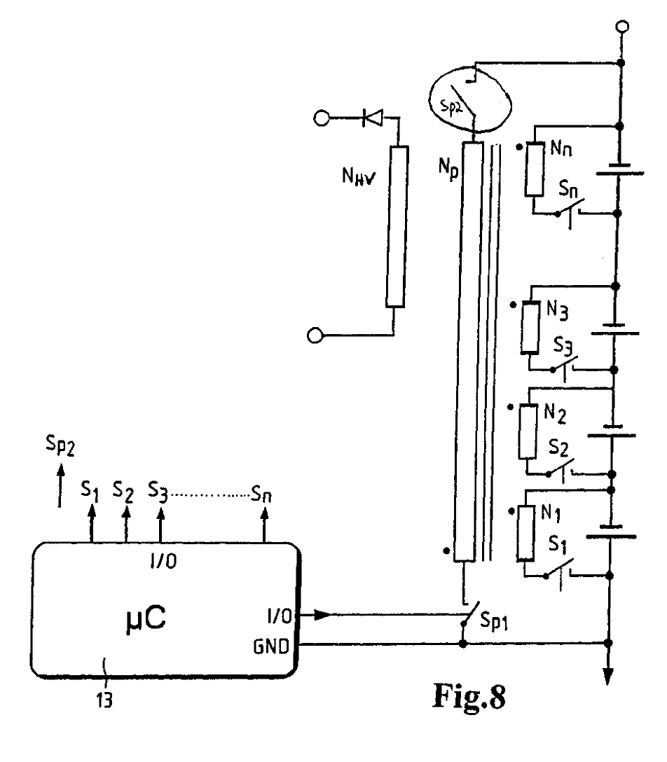

FIG. 8 shows a further exemplary embodiment of an electric drive system.

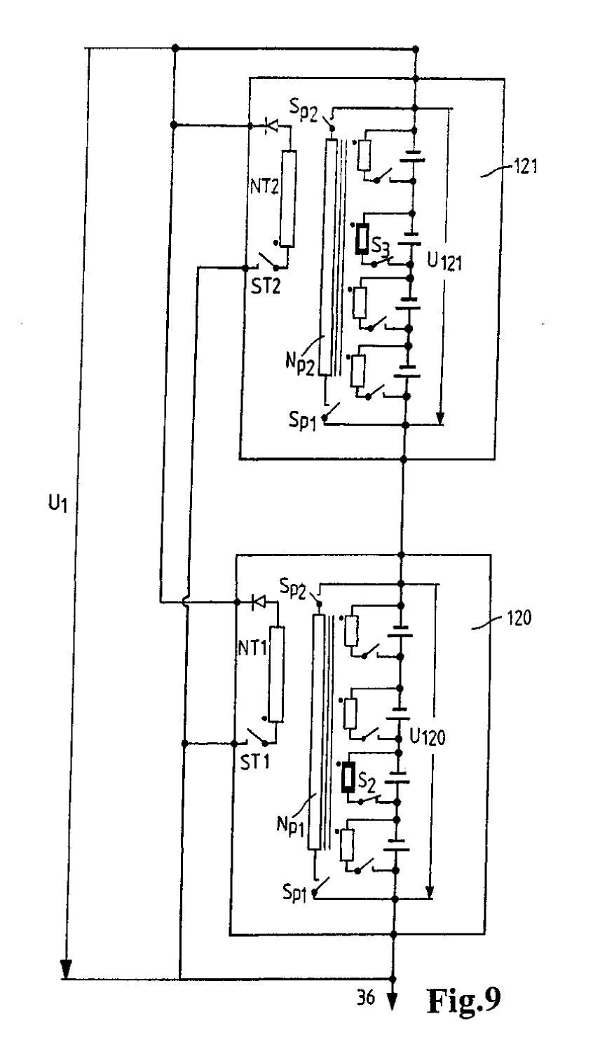

FIG. 9 shows the electricity consumption for charging and discharging the accumulators.

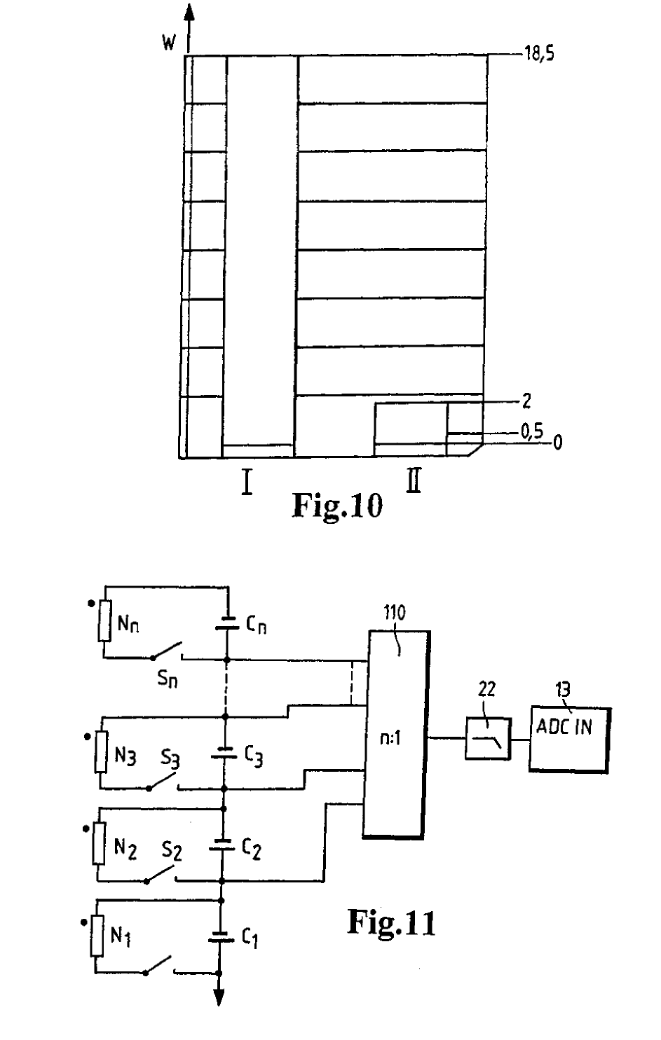

FIG. 10 shows a performance comparison of a conventional charging method and a charging method according to the invention.

FIG. 11 shows a section from the electric drive system according to a further exemplary embodiment.

FIG. 1 shows a side view of the basic structure of a bicycle 1 according to the invention with pedals which are operated by human power and with an electric drive unit 3. The pedals 2 and the electric drive unit 3 both act to move a chain 4 and thus the rear wheel 5. The pedal-driven vehicle is one example of a light electric vehicle, but they may also be wheelchairs or motor scooters.

FIG. 2 shows a circuit diagram of the electric drive system 3. The electric drive system 3 comprises an AC/DC converter 9, a transformer 12, a microprocessor 13, a DC/DC converter 14, a fuel cell 10, a voltage measuring circuit 15, a current measuring circuit 16 and a motor 17. The fuel cell 10, which is configured as a methanol fuel cell, for example, generates a voltage U_{B} of 24V. From this voltage the DC/DC converter 14 generates a so-called first voltage U1 of 40V which is applied between a node K and the earth 36. This first voltage U1 is also applied at the motor 17 so that it drives the vehicle when torque is required.

Also connected to the first voltage U1 is the voltage measuring circuit 15 which also contains power management circuits. This voltage measuring circuit 15 measures the first voltage U1 and contains information on expected consumption.

The voltage measuring circuit 15 causes the fuel cell 10 to increase the voltage U1 in accordance with the level of the first voltage U1 and the level of expected consumption.

The energy provided by the fuel cell 10 is stored in the series connection of accumulators C1 to Cn. Here a first terminal of the accumulator C1 is connected to the earth 36, while its second terminal is connected to the first terminal of the second accumulator C2. A second terminal of the second accumulator C2 is connected to the first terminal of the accumulator C3, to which the series of remaining accumulators is also connected. In a selected embodiment the number of accumulators is n=10 and each of the accumulators C1 to Cn therefore stores the electrical charge at a voltage of 4V.

In some types of accumulator, lithium ion accumulators for example, it is particularly important to ensure that an individual cell is not overcharged. If the voltage applied at one of the accumulators is too high the accumulator becomes defective and energy can therefore no longer be stored in of the entire series connection of accumulators.

The transformer 12 is provided to ensure that the accumulators C1 to Cn are charged evenly. The transformer 12 comprises a magnetisable core 11. Wound around this core 11 is a primary coil Np which comprises 90 windings in the exemplary embodiment. A first terminal A1 of the primary coil Np is connected to the node K, while a second terminal A2 of the primary coil is connected to a first terminal of a primary switch Sp1 which has a second terminal which is connected to the earth 36. The primary switch Sp1 also comprises a switching input. A connection between the first terminal and the second terminal is closed and opened dependent on this switching input.

In addition, the transformer 12 comprises n secondary coils. The first secondary coil N1, the second secondary coil N2, the third secondary coil N3 and the nth secondary coils Nₙ are indicated explicitly in FIG. 2. These secondary coils N1 to Nn comprise three windings which are placed around the core 11. The core 11 is magnetisable and serves to transmit power from the primary coil Np to a secondary coil or to a plurality of secondary coils N1 to Nn. Each of the secondary coils can be switched in parallel to one of the accumulators C1 to Cn.

The secondary coils N1 to Nn each comprise a first and a second terminal, each of which is located at one end of the totality of the windings. The first terminal of a secondary coil is connected to the second terminal of an accumulator, while the second terminal of the secondary coil is connected to a first terminal of a secondary switch, the second terminal of which is connected to the first terminal of the accumulator. A switching input of the secondary switch controls whether the electrical connection between the first terminal and the second terminal of the secondary switch is closed.

The second terminal of the first accumulator C1 is connected to the first terminal of the first Coil N1, the second terminal of which is connected to the first terminal of the first switch S1. The second terminal of the switch S1 is connected to the first terminal of the accumulator C1. Similarly, the second terminal of the second accumulator C2 is connected to the first terminal of the second secondary coil N2. The first terminal of the second switch S2 is connected to the second terminal of the second secondary coil N2 and its second terminal is connected to the first terminal of the second accumulator C2. The connections between the accumulators, secondary coils and switches for the remaining accumulators C3 to Cn are made in the same manner. The microcontroller 13 actuates the switches Sp1 and S1 to Sn of the transformer 12. By closing one of the secondary switches S1 to Sn a secondary coil is connected in parallel to an accumulator.

Alternatively the accumulators can be charged by the charging circuit 9 which is connected by a plug to an external mains network of 110 or 230V, for example. To this end the charging switch SL1 is closed, whereby the series connection consisting of charging switch SL1 and charging circuit 11 is connected to the series connection consisting of accumulators C1 to Cn, which are thereby charged. At the same time the fuel cell 10 is switched off. This manner of charging makes sense if energy from the socket is cheaper than the energy from the fuel cell.

If the fuel cell 10 is a reversible fuel cell, it is also possible to convert excess electrical energy in the fuel cell 10 into chemical energy in the fuel cell 10 in order to store it there.

FIG. 3 illustrates the discharging process of one of the accumulators in two phases. The charge states of the accumulators C1 to C6 are shown on the right-hand side next to the accumulators. The accumulators C1, C3, C4 and C6 are each charged to 90%, the second accumulator C2 is charged to 70%, while the fifth accumulator C5 is charged to 100%. The fifth accumulator C5 risks becoming defective if charged beyond 100%.

First, the charge states of the individual accumulators C1 to C6 are measured by the microprocessor 13 by closing a secondary switch S1 to Sn. The voltage is then measured at the second terminal A2 of the primary coil permitting the charge states of the individual accumulators C1 to C6 to be determined.

During measurement it is determined that the fifth accumulator C5 must be discharged. In a first phase, which is shown on the left-hand side of figure, the fifth secondary switch S5 is closed, thereby increasing the current in the fifth secondary coil N5. This changes the magnetic field in the core 11, whereby energy from the fifth secondary coil N5 is transmitted to the core 11.

In a second phase, which is illustrated on the right-hand side of the figure, the fifth secondary switch S5 is first reopened before the primary switch Sp1 is closed. The magnetic field in the core 11 induces a voltage in the primary coil Np which increases the first voltage U1 applied by the series connection of the accumulators C1 to C6. As only one of the accumulators C1 to C6 is discharged, a relatively small amount of charge is moved and the increase in the first voltage U1 is not so great as to represent a risk for the electric drive system 3. FIG. 4 shows selected signal shapes of the voltages and currents from FIG. 3. The signal curves illustrated are for a period t_{cycle} of 40 μs. The period is divided into a secondary phase PS, a primary phase PP and a pause.

The primary switch SP1 and the fifth secondary switch S5 are each designed as NMOS transistors. Their respective connections are closed if the voltage at their control input exceeds 2V. During the secondary pulse PS the fifth secondary switch S5 is closed by the application of a voltage of 5V at the gate of the fifth secondary switch S5. This causes the current IDS through the fifth secondary coil N5 to increase from OA to approximately 18A. This transmits energy to the core 11. At the start of the primary phase following the secondary phase the voltage at the gate of the fifth switch S5 is reduced to 0V. In addition, the voltage at the gate of the primary switch SP1 is increased from 0 to 5V so that the primary switch SP1 is closed.

Voltage is then induced in the primary coil NP so that a current of initially 5 A, subsequently falling linearly to 0 A, is generated. This increases the first voltage U1. At the end of the primary pulse the voltage at the gate of the primary switch SP1 is also reduced to 0V so that none of the switches SP, S1 to S6 is open during the pause.

The pause is followed by another secondary phase if another of the accumulators C1 to C6 is to be discharged.

FIG. 5 illustrates the charging of one of the accumulators in two phases. In the first phase the accumulators C1 to C6 are charged in the same manner as in the first phase in FIG. 3. The control circuit has detected that the second accumulator C2 was insufficiently charged. The process for the selective charging of the accumulator C2 is thus started. During a first phase the first primary switch SP1 is closed, causing a reduction in voltage via the primary coil NP. The current thus generated effects a change in the magnetic field in the core 11, whereby energy is transmitted to the core 11.

In the second phase, illustrated on the right-hand side in FIG. 5, the primary switch SP1 is first opened, before the second secondary switch S2 is closed. As a result the second secondary coil N2 is connected in parallel to the second accumulator C2. In the second secondary coil N2 a voltage is built up and subsequently reduced by a discharge current. This discharge current 12 causes the second accumulator C2 to be charged to a value of 70%+x of the charging capacity.

FIG. 6 show the signal curves at selected nodes during the phases illustrated in FIG. 5. The period t_{cycle} is subdivided into a primary phase, a secondary phase and a pause which follow one after the other.

the primary phase the gate of the primary switch SP1 is actuated with a voltage of 5V to close the primary switch SP1. This increases the current in the primary coil Np from 0 A to approximately 4 A. At the start of the secondary phase the voltage at the gate of the primary switch SP1 is reduced to zero and then the voltage at the gate of the second secondary switch S2 is increased to 5v. The resulting current, initially 15 A, drops to 0 A within 12 μs.

Using the circuit, energy from the series connection of accumulators C1 to Cn can be transmitted to a single one of the accumulators C1 to Cn. It is particularly advantageous that this requires only one transformer 12. A plurality of transformers would increase power loss. This is particularly advantageous because the power which is provided by the fuel cell 10 is provided first at the series connection of the accumulators C1 to Cn and it is therefore possible to transfer energy fast and effectively to the individual accumulators C1 to Cn.

It is also advantageous that energy can be transported in both directions, i.e. from a single accumulator to the series connection and from the series connection to a single accumulator, with the same circuit and with the primary switch Sp1.

FIG. 7 shows the circuit for measuring the charging capacities of the accumulators C1 to Cn. The microcontroller 13 actuates the secondary switches S1, S2, S3 to Sn selectively one after the other to switch on each of them for a short period one after the other. Switching them on generates a voltage in one of the secondary coils N1 to Nn which effects a change in the voltage at the second terminal A2 of the primary coil Np. The voltage is applied at the input of the low-pass filter 22, the output of which is connected to the input ADCin of the microcontroller 13. This input is the input of an analog/digital converter by use of which the filtered voltage is first converted from analog and then processed further digitally.

Depending on the voltage level at the accumulator, the voltage level at the second terminal A2 of the primary coil NP is smaller or larger. By means of the devices described the voltages are measured and compared via the accumulators C1 to Cn. If one of the voltages is greater than 5% of the mean value of all the voltages the corresponding accumulator is discharged. If, on the other hand, the voltage at one of the accumulators is less than 5% of the mean value of all the voltages at the accumulators, this accumulator is charged. This ensures that during all charging and discharging processes the accumulators all remain charged to approximately the same level, thereby preventing the overcharging of an accumulator and ensuring that the accumulators are evenly charged.

It is also possible, in addition to the individual charging processes, to charge or discharge all the accumulators C1 to Cn simultaneously by closing all secondary switches S1 to Sn simultaneously. In the selected embodiment this is provided only for short periods. After these short periods, the voltages are measured again and the accumulators are selectively charged or discharged as required.

A block of ten accumulators shown in FIG. 2 has a capacity from 10 to 20 Ah. The transformer is approximately 4 cm×4 cm×1 cm in size and can transmit approximately 10 A.

Efficiency is 98%, i.e. only 2% of the power is converted into heat loss.

FIG. 8 shows a further embodiment of a transformer. An additional tertiary coil Nhv is wound around the core 11. It is therefore also possible to transmit the energy to a further series connection of accumulators. In the following, a series connection of accumulators is also referred to as a block.

In this manner, energy from the primary coil Np can be transmitted to the tertiary coil Nhv and vice versa. Alternatively, power can also be connected to the tertiary coil Nhv from the secondary coils N1 to Nn.

FIG. 9 shows an exemplary embodiment with two blocks 120 and 121 both of which comprise a series connection of accumulators C1 to Cn and transformers 12 connected in parallel thereto. The negative pole of the block 120 is connected to the earth 36 and its positive pole is connected to the negative pole of the block 121, the positive pole of which is connected to the node K. It is also possible to connect further blocks in series with the blocks 120 and 121.

The block 120 provides a voltage U120, while the block 121 provides a voltage U121. Both voltages U120 and U121 add up to the first voltage U1. The primary coils Np serve to transmit power from an accumulator to an entire block 120 or 121. The block 121 contains a tertiary switch St1, a secondary coil Nt1 and a diode D1. The first terminal of the tertiary switch St1 is connected to the earth 36, while its second terminal is connected to a first terminal of the tertiary coil Nt1, the second terminal of which is connected to the anode of the diode D1. The cathode of the diode is connected to the node K.

Also connected together in series are the tertiary switch St2, the tertiary coil Nt2 and the diode D2. A first terminal of the switch St2 is connected to the earth. Its second terminal is connected to a first terminal of the tertiary coils Nt2. The second terminal of the tertiary coil Nt2 is connected to the anode of the diode D2, the cathode of which lies at the potential of the voltage U1.

By means of the tertiary coils Nt1 and Nt2 it is possible to feed power provided by the first voltage into the individual accumulators C1 to Cn of the blocks 120 and 121.

FIG. 10 shows a comparison of the power consumption of a charging circuit known from the state of the art with the active charging circuit presented. The individual accumulators have a target voltage of 3.6V. The charging circuit labelled I comprises a series connection of resistors with connection nodes which are selectively connected to a terminal of an accumulator. The power loss for the charging and discharging of the accumulators is accordingly great such that a power consumption of 18.5 W was simulated, wherein 18 W is caused by the actual recharging process and 0.5 W is consumed by the control circuit. The charging circuit shown, labelled II, represents one of the active charging circuit of an electric drive system as presented above.

The power consumption for the active charging circuit is 2 W, 0.5 W of which is once again accounted for by the control circuit which is realized essentially in the microcontroller.

FIG. 11 shows a section from an electric drive system according to a further exemplary embodiment. The figure shows the series connection of accumulators C1 to Cn, the secondary coils S1 to Sn and the secondary coils N1 to Nn as known from FIG. 2, for example.

There is a difference with respect to the measuring circuit 13. An n:1 multiplexer is provided which switches one of the intermediate nodes between the capacitors C1 to Cn to the input of the low-pass filter 22, the output of which is connected to the input ADCin of the microprocessor 13. The measurement is carried out in the microprocessor 13 in the same manner as in the exemplary embodiment according to FIG. 7.

### LIST OF REFERENCE NUMERALS

1 Bicycle
2 Pedals
3 Electric drive unit
9 Core
10 Fuel cell
11 AC/DC converter
12 Transformer
13 Microcontroller
14 DC/DC converter
15 Voltage measuring circuit
16 Current measuring circuit
17 Motor
22 Low-pass filter
C1 First accumulator
C2 Second accumulator
C3 Third accumulator
S1 First switch
S2 Second switch
S3 Third switch
N1 First secondary coil
N2 Second secondary coil
N3 Third secondary coil
Np Primary coil
Sp1 Primary switch
U1 First voltage
U120 First partial voltage
U121 Second partial voltage
UB Fuel cell voltage
SL1 Charging circuit switch

1. Electric power supply unit (3) for a vehicle comprising the following:
a power source (10) for generating a first voltage (U1),
a series connection of accumulators (C1, C2, C3, Cn) connected to the first voltage (U1) with at least one first accumulator (C1) and one second accumulator (C2),
a transformer (12) which comprises a magnetisable core (11), a primary coil (Np), a first secondary coil (N1) and a second secondary coil (N1), wherein the primary coil (Np) can be switchably connected to the first voltage (U1) by a primary switch (Sp1),
a first secondary switch (S1) for connecting the first secondary coil (N1) in parallel to the first accumulator (C1),
and a second secondary switch (S2) for connecting the second secondary coil (N2) in parallel to the second accumulator (C2), wherein the first secondary switch (S1) and the second secondary switch (S2) can be switched independently of one another.

2. Electric power supply unit according to claim 1, characterised in that
the power source contains a fuel cell (10).

3. Electric power supply unit according to claim 1,
characterised in that
the secondary switches are each designed as MOS transistors.

4. Electric power supply unit according to claim 1,
characterised by
a measuring circuit for measuring the voltage at a terminal (A2) of the primary coil (Np) or the current in the primary coil (Np).

5. Electric power supply unit according to claim 1,
characterised by
a measuring circuit for measuring the voltage at a terminal of a secondary coil (N1, N2) or the current into a secondary coil (N1, N2).

6. electric power supply unit according to claim 5 characterised by
a selection switch (110) for selecting a connection from the measuring circuit to a terminal of one of the secondary coils (N1, N2).

7. Electric power supply unit according to one of claims 1 to 6,
characterised in that
a DC/DC converter (14) is provided between the fuel cell (10) and the first voltage (U1).

8. Electric power supply unit according to claim 1,
characterised in that
a charging circuit (9) is provided for charging the accumulators (C1, C2, C3, Cn) and/or the fuel cell (10) from an external electrical power source.

9. Electric power supply unit according to claim 1,
characterised in that
the accumulators (C1, C2, C3, Cn) are each realized as lithium ion accumulators.

10. Electric power supply unit according to claim 1,
characterised by
a control circuit (13) for switching the secondary switches (S1, S2, S3, Sn).

11. Electric power supply unit according to claim 1,
characterised by
a voltage measuring circuit (15) for measuring the first voltage (U1).

12. Electric power supply unit according to claim 1,
characterised in that
at least one further series connection (121) of accumulators is provided and a further coil (Np1) is provided which can be connected to the partial voltage (U120) which is applied at the first series connection of accumulators.

13. Electric power supply unit according to one of claims 1 to 12,
characterised in that
the first voltage (U1) is applied at a stack of a fuel cell.

14. Light electric vehicle with an electric power supply unit (3) according to claim 1.

15. Light electric vehicle according to claim 14,
characterised in that
it is a pedal-operated vehicle with electrical support, in particular a bicycle, with one drive system operated by human power and one electric drive system, wherein a power output from the electric drive system is controlled in accordance with the changes in the output of the human-powered drive system.

16. Method for operating an electric power supply unit of a drive unit of a vehicle with the following steps:
provision of an electric power supply unit according to claim 1,
closure of the primary switch (Sp1),
opening of the primary switch (Sp1),
subsequent closure of the first secondary switch (51).

17. Method according to claim 16,
characterised by the following steps before the primary switch closure step (Sp1):
opening of the primary switch (Sp1) and the secondary switches (51, S2),
measurement of the voltage at the first accumulator (C1) and measurement of a voltage at the second accumulator (C2).

18. Method according to claim 17,
characterised in that
if the voltage at the first accumulator is greater than the voltage at the second accumulator, a step involving a subsequent closure of the second secondary switch is carried out instead of the step involving the subsequent closure of the first secondary switch.

19. Method according to claim 17,
characterised in that
the measurement of the voltage at the first accumulator is carried out by measuring a voltage or a current at a terminal (A1, A2) of the primary coil (Np).
